(19) United States
(12) Patent Application Publication
(10) Pub. No.: US 2020/0253134 A1
(43) Pub. Date: Aug. 13, 2020

(54) PREFABRICATED RAISED BED GARDEN ENCLOSURE

(71) Applicants: Jennifer Olsen, Salt Lake City, UT (US); E. Kendall Lyman, Salt Lake City, UT (US)

(72) Inventors: Jennifer Olsen, Salt Lake City, UT (US); E. Kendall Lyman, Salt Lake City, UT (US)

(21) Appl. No.: 16/273,819

(22) Filed: Feb. 12, 2019

(51) Int. Cl. A01G 9/28; A01G 9/20

(52) U.S. Cl. CPC A01G 9/28; A01G 9/20

(57) ABSTRACT

A novel prefabricated garden box for use in growing plants with a raised bed, comprising a plurality of posts, beams, crossbeams, an inclined roof and slidably rigid transparent or translucent door(s). The enclosure includes multi-channel slidetracks and is fillable with soil and gravel under conditions that provide a suitable growing environment. The garden box, when fully assembled, rests on a ground surface or subgrade and may be preferably constructed to conform to dimensions suitable for shipping, packaging and transport before assembly by an end user/gardener.

### FIELD OF THE INVENTION

This invention relates to agriculture and gardening, and more particularly relates to a prefabricated garden box for facilitating growth of plants in confined spaces while providing protection against pests, weeds, inclement weather and cold.

### BACKGROUND

### Description of The Related Art

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The present invention relates to a prefabricated garden box for use in growing fruits, vegetables or other plants. More specifically, the present invention relates to a planter or garden box having a raised bed which allows for the growing of plants in selected spaces while providing a protective barrier against foraging animals, weather, and frigid temperatures, including perishable food sources.

Greenhouses and garden boxes have been known in the prior art and have become ever more popular as interest in nutrition and fresh eating grows and population density increases. Gardening is a pastime long shared by many, but one which has typically been enjoyed more heavily in open rural spaces throughout history rather than confined urban or semi-urban spaces where much of the population in migrating.

Gardening in general is an art fraught with problems, including protection of the plants from animals, bugs, pests and weeds, temperature control, sunlight control, fertilization problems, irrigation difficulties, and the like. The physical difficulty of gardening also takes a toll on gardeners, who can suffer from back problems and muscle stiffness. Many gardeners have come to prefer tending to gardens confined to raise garden boxes, which are more easily accessible without bending over and are less labor-intensive.

Garden boxes are typically built custom in place out of four simple sides with soil disposed within a recess created by the four adjoining sides of the garden box. There exists a need in the art for a prefabricated garden box with an enclosure for added protection, which is easily transported, assembled, and which provides doors for access to plants within the garden box.

### SUMMARY

From the foregoing discussion, it should be apparent that a need exists for a prefabricated garden box and enclosure with a raised bed. Beneficially, such a garden box would provide means of curing the deficiencies in the prior art described above.

The present invention has been developed in response to the present state of the art, and in particular, in response to the problems and needs in the art that have not yet been fully solved by currently available garden boxes. Accordingly, the present invention has been developed to provide a prefabricated garden enclosure having a raised bed comprising: eight or more wooden panels affixed together using a plurality of corner brackets and tension brackets to form a substantially rectangular recess enclosed on all sides; a first multi-channel slidetrack positioned on and above two or more of the wooden panels for guiding one or more slidably-affixed transparent, rigid panels adapted to function as doors; six or more vertically-rising parallel posts affixed to the wooden panels; two or more beams, each beam affixed to three or more of the wooden posts; three or more crossbeams, each crossbeam affixed to two or more of the wooden posts; and an inclined roof comprising: two or more polycarbonate panels affixed in place; a plurality of triangularly-shaped rafters; one or more support braces affixed perpendicularly to the posts; and a second slidetrack affixed to a lower surface of the support brace.

The prefabricated garden enclosure may comprise a trellis suspended from a beam. In other embodiments, the prefabricated garden enclosure having a raised bed further comprises a plurality of trellises suspended from a beam.

The prefabricated garden enclosure may further comprise, in some embodiments, four or more transparent rigid panels affixed in place to two or more posts.

The prefabricated garden enclosure having a raised bed may comprise four or more wood panels slidably-affixed to a plurality of posts.

The prefabricated garden enclosure may also comprise a bed raised above a subgrade affixed to the posts.

The prefabricated garden enclosure may alternatively comprise a slidable, transparent polycarbonate door slidable within the first dual channel slidetrack and the second dual channel slidetrack.

In some embodiments, the wooden panels are formed of redwood lumber.

A second prefabricated garden enclosure having a raised bed is also provided, the prefabricated garden enclosure comprising: eight or more wooden panels affixed together using a plurality of corner brackets and tension brackets to form a substantially rectangular recess enclosed on all sides; a first dual channel slidetrack positioned on and above two or more of the wooden panels for guiding one or more slidably-affixed transparent, rigid panels adapted to function as doors; six or more vertically-rising parallel posts affixed to the wooden panels; two or more beams, each beam affixed to three or more of the wooden posts; three or more crossbeams, each crossbeam affixed to two or more of the wooden posts; and an inclined roof comprising: two or more polycarbonate panels affixed in place; a plurality of triangularly-shaped rafters; one or more support braces affixed perpendicularly to the posts; a second slidetrack affixed to a lower surface of the support brace; a trellis suspended from a beam; three or more transparent polycarbonate panels affixed in place to two or more posts; further comprising a bed raised above a subgrade affixed to the posts.

The wooden panels may be formed of redwood lumber.

Two posts and three beams may further comprise a forward sliding panel door assembly defining: a sliding panel recess adapted to receive sliding transparent doors, and a door panel recess positioned above the sliding panel recess adapted to receive a rigid transparent material.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a forward side perspective view of an assembled, prefabricated garden box enclosure with a raised bed in accordance with the present invention;

FIG. 2 is a forward side perspective view of a partially disassembled, prefabricated garden box enclosure with a raised bed in accordance with the present invention;

FIG. 3 is a forward side perspective view of a partially disassembled, prefabricated garden box enclosure with a raised bed in accordance with the present invention;

FIG. 4 is a forward side perspective view of the roof of a partially disassembled, prefabricated garden box enclosure with a raised bed in accordance with the present invention;

FIG. 5 is a forward side perspective view of boards of a disassembled, prefabricated garden box enclosure with a raised bed in accordance with the present invention;

FIG. 6 is a flow chart illustrating the steps of a method of forming a garden box enclosure with a raised bed in accordance with the present invention;

FIG. 7 is a forward side perspective view of a forward sliding door assembly of a prefabricated garden box enclosure with a raised bed in accordance with the present invention; and

FIG. 8 is a forward side perspective view of a forward sliding door assembly of a prefabricated garden box enclosure with a raised bed in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

It is an object of the present invention to provide a novel prefabricated garden box for use in growing plants with a raised bed, comprising a plurality of posts, beams, crossbeams, an inclined roof and slidably rigid translucent or transparent door(s). The provided enclosure with a raised bed includes multi-channel slidetracks and is finable with soil and gravel under conditions that provide a suitable growing environment. The enclosure, when fully assembled, rests on a ground surface or subgrade and may be preferably constructed to conform to dimensions suitable for shipping, packaging and transport before assembly by an end user/gardener.

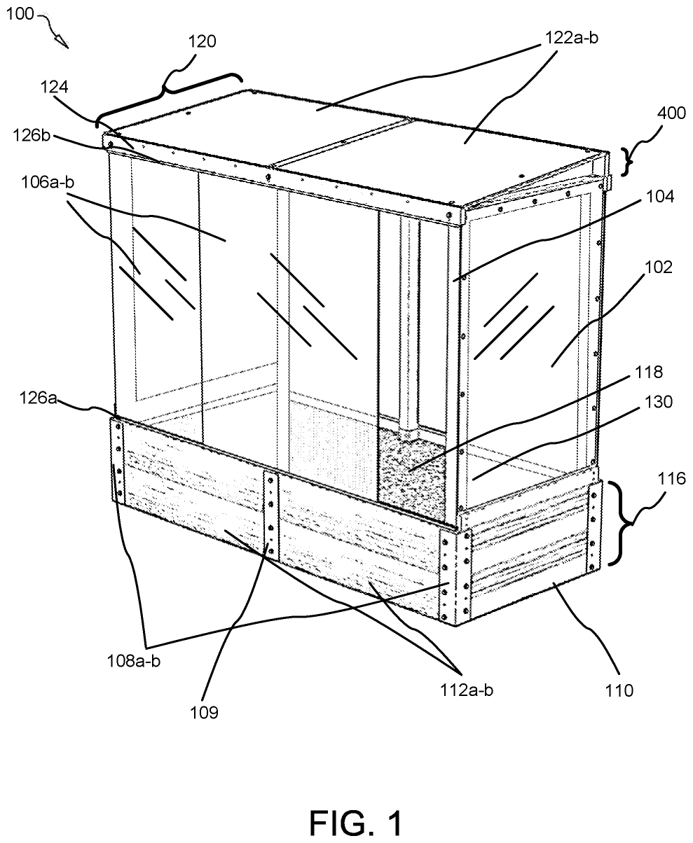

FIG. 1 is a forward side perspective view of an assembled, prefabricated garden box enclosure with a raised bed 100 in accordance with the present invention.

The raised bed enclosure 100 may comprise a plurality of corner brackets 108a-b, as well as a tension bracket 109. These brackets 108, 109 are affixed to wooden panels 112, 110 to form a four-sided rectangular recess enclosed on all sides. The raised bed enclosure 100 comprises rigid panels 102 and 122a-b. These panels 102, 122 may be transparent or translucent and are affixed in place to posts 104 using means known to those of skill in the art, including adhesive, screws, bolts, rivets, friction fits, and the like.

The raised bed enclosure 100 comprises a trellis (indicated at 510 below). The trellis 510 may be suspended from a beam 202. In various embodiments, a third beam 202 is affixed to one or more crossbeams 406. The enclosure 100 may comprise a plurality of trellises 510 suspending from beams 202 and/or affixed to posts 104 and/or resting on the bed/tub 130.

In various embodiments, the enclosure comprises a tub 130 or bed. The tub 130 is affixed to the posts 104 and is disposed above a subgrade or ground surface on which the posts are positioned.

The raised bed enclosure 100 comprises a plurality of forward panels 112. In the shown embodiment, the enclosure 100 comprises four forward panels 112 on the front of the enclosure 100 and also comprises four panels 112 on the rear of the enclosure 100.

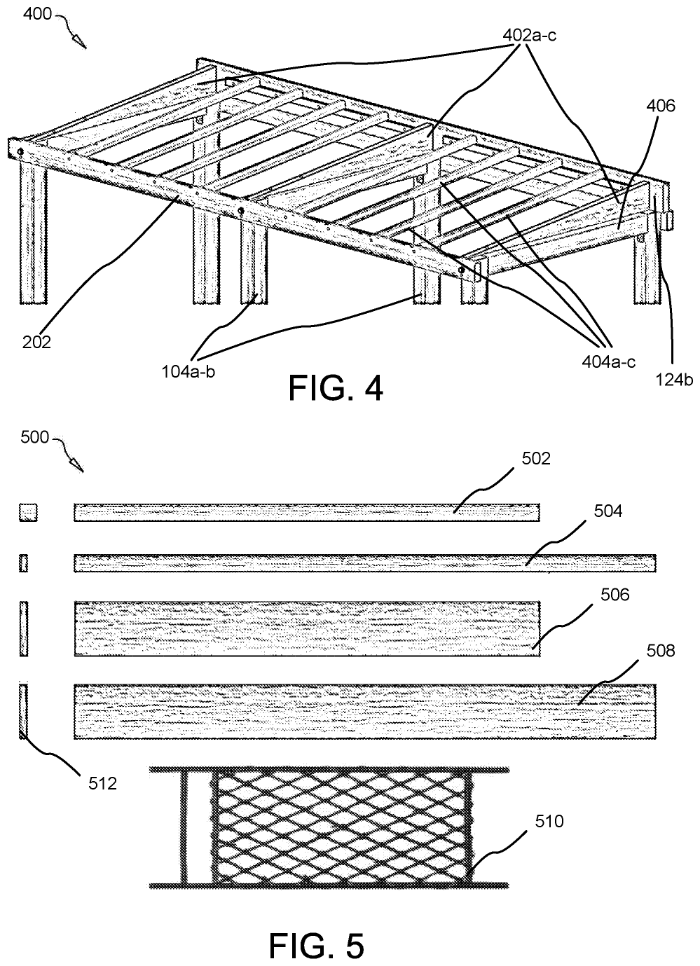

The enclosure 100 comprises a plurality of crossbeams 406 (indicated in FIG. 4 below) which interconnect the posts 104.

The enclosure 100 comprises a support brace 124 which is affixed in the shown embodiment to an inverted dual channel slidetrack 126b (or multi-channel slidetrack).

A plurality of bolts, nuts, screws and nails may be used to form the raised bed enclosure 100, including ⅝ coated screws, staples, bonded washers, shoulder screws, angle brackets, and anchor bolts.

The sliding rigid panel 106 may slide within an upper (inverted) and a lower multi-channel slidetrack 126, the upper slidetrack positioned to and below the support brace 124 and the lower slidetrack 126 affixed to and above a forward panel 112. In some embodiments, the enclosure 100 comprises two or more rigid panels 106 both of which slide within multi-channel slidetracks on the enclosure.

The enclosure 100 may comprise weather stripping as well.

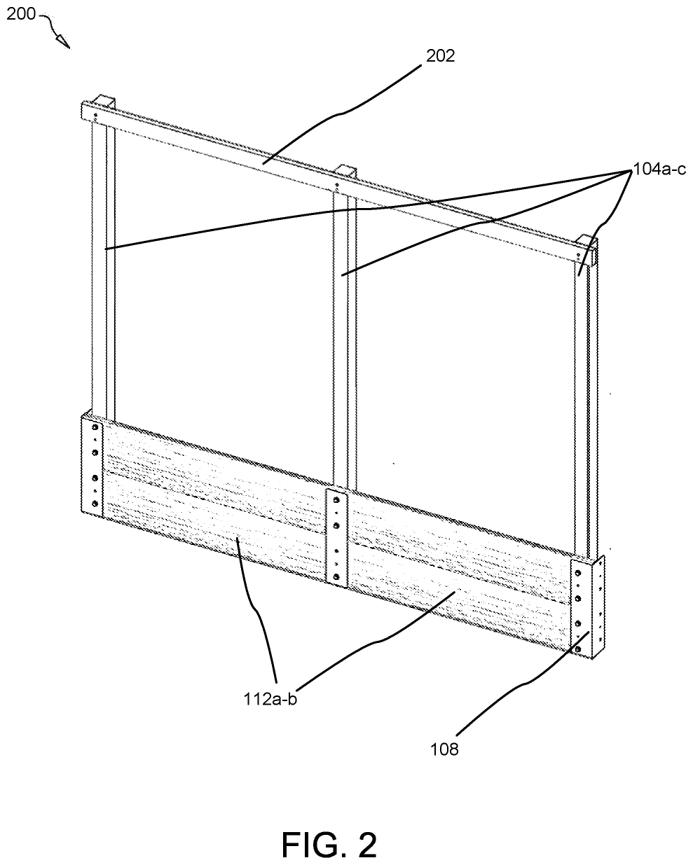

FIG. 2 is a forward side perspective view of a partially disassembled, prefabricated garden box enclosure with a raised bed 200 in accordance with the present invention.

The posts 104 rise parallel to one another and are affixed to a beam 202. The beam 202 may double as the support brace 124 or alternatively may affixed above the posts 104 and abut a top surface of the posts 104 using means known to those of skill in the art.

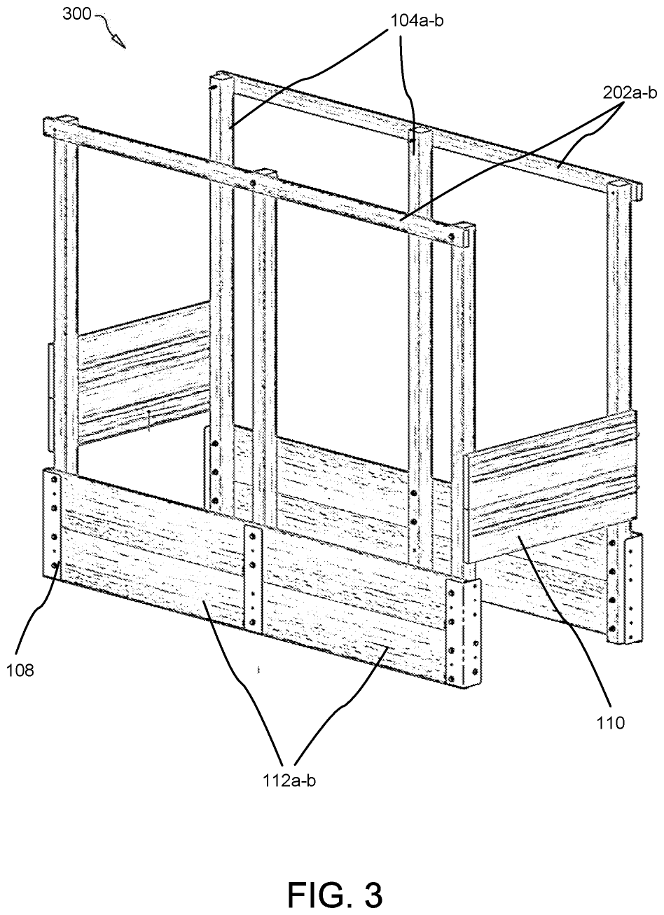

FIG. 3 is a forward side perspective view of a partially disassembled, prefabricated garden box enclosure with a raised bed 300 in accordance with the present invention.

A plurality of wooden posts 104, cut from any suitable wood, including redwood, alder, oak, pine, cherry and other woods known to those of skill in the art, may be affixed to the remaining wooden panels 112 (or front panels 112). In various embodiments, the wood panels 110 are side panels which slidably engage a corner bracket 108 and are permanently affixed in place.

FIG. 4 is a forward side perspective view of the roof 400 of a partially disassembled, prefabricated garden box enclosure with a raised bed in accordance with the present invention.

The roof 400 is inclined as shown. The roof 400 may comprise a plurality of rafters 404 (or joists) which taper from end to another to form substantially triangular pieces. The rafters 404 may be joined to one or more beams 202 in parallel orientation. In the shown embodiment, the roof 400 comprises eight rafters 404 which incline from front to back of the enclosure 100 and roof 400.

FIG. 5 is a forward side perspective view of a boards 500 of a disassembled, prefabricated garden box enclosure with a raised bed in accordance with the present invention.

Examples of the boards 500 may include a 4x4x8 foot 502 board, optionally milled from redwood or another wood, a 2×4×10 foot 504 board, a 2×12×8 foot 506 redwood board, a 2×12×10 foot board, a 2×12×10 foot 508 board, and trellis 510.

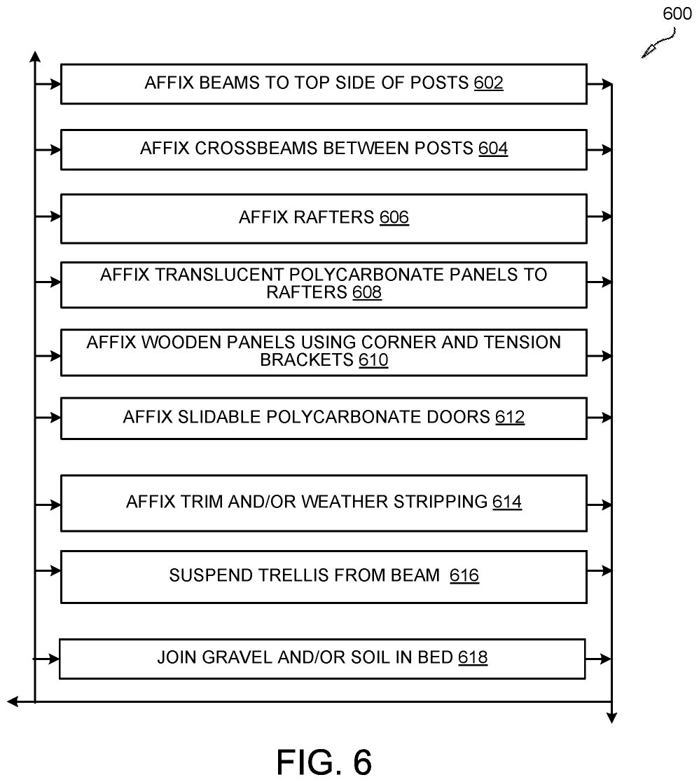

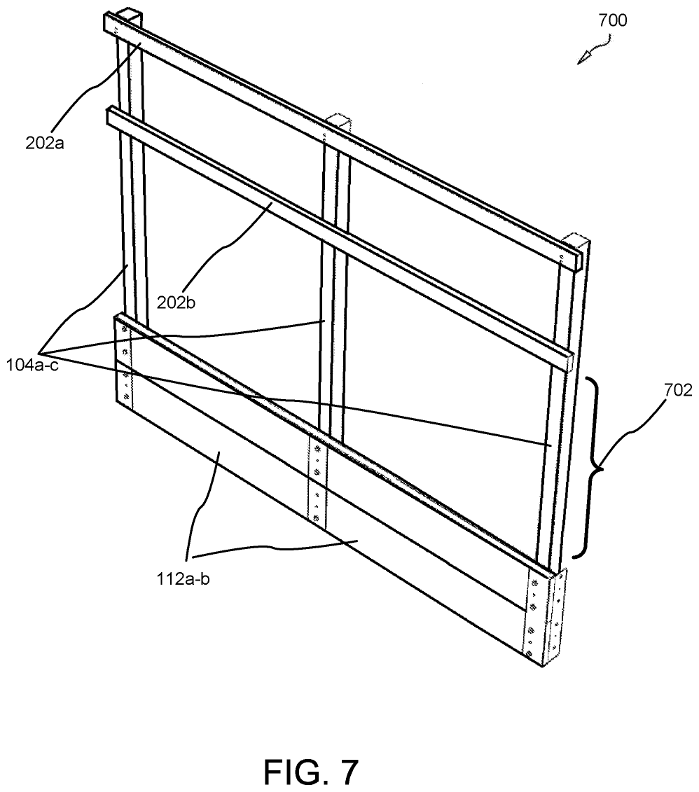

FIG. 6 is a flow chart illustrating the steps of a method 600 of forming a garden box enclosure with a raised bed in accordance with the present invention.

The prefabricated enclosure with a raised bed 100 is formed in some embodiments by following inter alia the steps shown in FIG. 6, including first affixing beams 202 to the posts 104 at step 602, then affixing crossbeams between the posts 104 at step 604, and subsequently affixing rafters 404a-c or 402a-c to the crossbeams to form the roof 400.

Thereafter, the method 600 proceeds 608 when transparent or translucent polycarbonate panels are affixed to rafters 608. Wooden panels, in some cases redwood, are affixed to form a rectangular recess enclosed on all sides 610. Trim and weather stripping may be affixed 614 and one or more trellises suspended from beam(s) 616 or otherwise affixed to the enclosure 100.

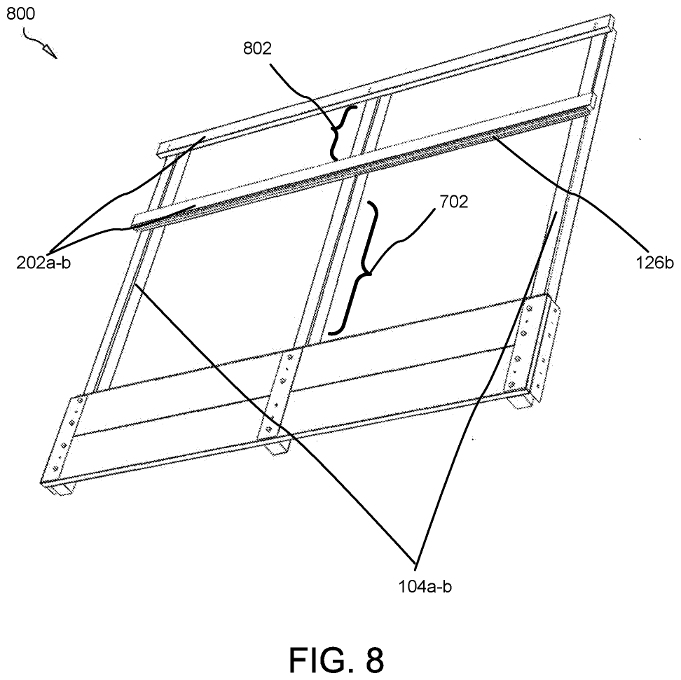

FIG. 7 is a forward side perspective view of a forward sliding door assembly 700 of a prefabricated garden box enclosure with a raised bed in accordance with the present invention.

In various embodiments, the raised bed garden enclosure comprises a prefabricated sliding door assembly 700 (or panel 700) affixed to the forward surface of the raised garden box enclosure. This panel 700 comprises smaller sliding panels 106, and small sliding panel recesses 702, than those show in embodiment 100. The height of the sliding panel recess 702 shown in FIG. 7 is four feet, but may vary from six inches to more than ten feet in height.

A dual channel (shown in FIG. 1) or multi-channel slide track 126 is mounted to the top of the beam 202 or board 112 while a second multi-channel slide track is mounted to the bottom of a higher beam 202 just above the transparent panels. The multi-channel slide tracks 126, the beams to which the multi-channel slide tracks are mounted, and the posts 104 define the sliding panel recess 702. The embodiment illustrated in FIG. 7 will better accommodate stronger wind locations by having shorter sliding transparent panels 106.

FIG. 8 is a forward side perspective view of a forward sliding door assembly 800 of a prefabricated garden box enclosure with a raised bed in accordance with the present invention.

In various other embodiments, a permanent window of approximately two feet in height is affixed in a window panel recess 802 as shown. The window panel recess is defined by two beams 202a-b and two posts 104a-b and positions above the sliding panel recess 702. Stronger, more rigid, transparent or translucent material may position in non-slidable fashion within the window panel recess 802.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A prefabricated garden enclosure having a raised bed comprising:
eight or more wooden panels affixed together using a plurality of corner brackets adapted to protect a corner from impact damage and using tension brackets to form a substantially rectangular recess enclosed on all sides;
a first multi-channel slidetrack positioned on and above two or more of the wooden panels for guiding one or more slidably-affixed transparent, rigid panels adapted to function as doors;
four or more vertically-rising parallel posts affixed to the wooden panels;
two or more beams, each beam affixed to three or more of the wooden posts;
two or more crossbeams, each crossbeam affixed to two or more of the wooden posts; and
an inclined roof comprising:
two or more polycarbonate panels affixed in place;
a plurality of triangularly-shaped rafters;
one or more support braces affixed perpendicularly to the posts; and
a second slidetrack affixed to a lower surface of the support brace.

2. The prefabricated garden enclosure having a raised bed of claim 1, further comprising a trellis suspended from a beam.

3. The prefabricated garden enclosure having a raised bed of claim 1, further comprising a plurality of trellises suspended from a beam.

4. The prefabricated garden enclosure having a raised bed of claim 1, further comprising four or more transparent rigid panels affixed in place to two or more posts.

5. The prefabricated garden enclosure having a raised bed of claim 1, further comprising four or more wood panels slidably-affixed to a plurality of posts.

6. The prefabricated garden enclosure having a raised bed of claim 1, further comprising a bed raised above a subgrade affixed to the posts.

7. The prefabricated garden enclosure having a raised bed of claim 1, further comprising a slidable, transparent polycarbonate door slidable within the multi-channel slidetrack and the second multi-channel slidetrack.

8. The prefabricated garden enclosure having a raised bed of claim 1, wherein the wooden panels are formed of one of: redwood lumber, pine lumber, and oak lumber.

9. The prefabricated garden enclosure having a raised bed of claim 1, wherein two posts and three beams further comprising a forward sliding panel door assembly defining:
a sliding panel recess adapted to receive sliding transparent doors, and
a door panel recess positioned above the sliding panel recess adapted to receive a rigid transparent material.

10. A prefabricated garden enclosure having a raised bed comprising:
eight or more wooden panels affixed together using a plurality of corner brackets and tension brackets to form a substantially rectangular recess enclosed on all sides;
a first dual channel slidetrack positioned on and above two or more of the wooden panels for guiding one or more slidably-affixed transparent, polycarbonate panels adapted to function as doors;
six or more vertically-rising parallel posts affixed to the wooden panels;
two or more beams, each beam affixed to three or more of the wooden posts;
three or more crossbeams, each crossbeam affixed to two or more of the wooden posts; and
an inclined roof comprising:
two or more polycarbonate panels affixed in place;
a plurality of triangularly-shaped rafters;
one or more support braces affixed perpendicularly to the posts;
a second slidetrack affixed to a lower surface of the support brace;
a trellis suspended from a beam;
three or more transparent polycarbonate panels affixed in place to two or more posts;
further comprising a bed raised above a subgrade affixed to the posts.

11. The prefabricated garden enclosure having a raised bed of claim 10, wherein the wooden panels are formed of redwood lumber.

12. The prefabricated garden enclosure having a raised bed of claim 10, wherein two posts and three beams further comprising a forward sliding panel door assembly defining:
a sliding panel recess adapted to receive sliding transparent doors, and
a door panel recess positioned above the sliding panel recess adapted to receive a rigid transparent material.
